(19) United States
(12) Patent Application Publication
(10) Pub. No.: US 2008/0225018 A1
(43) Pub. Date: Sep. 18, 2008

(54) Handheld Electronic Processing Apparatus and a Method of Operating the Same

(76) Inventor: Seng Hong Louis Pang, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/088,162

(22) PCT Filed: Sep. 30, 2005
(86) PCT No.: PCT/SG05/00333

§ 371 Date: Mar. 26, 2008

(51) Int. Cl. G06F 3/033; G06F 1/16

(52) U.S. Cl. 345/179; 361/681; 713/300

(57) ABSTRACT

A personal digital assistant (PDA) (10) includes a casing (30) in which a touch-sensitive display screen (20) is mounted. The casing (30) also has a stylus-receiving bore (32) formed therein. A stylus (40) is provided for data input via the screen (30) and is stored in the bore (32). A switch is mounted in the casing (30) adjacent the bore (32) and is closed when the stylus is inserted into the bore (32). An output from the switch (50) is used to move the PDA (10) between a power down mode and an operational power mode. In the power down mode, the screen (20) may be turned off, a backlight for the screen (20) may be turned off, or the PDA (10) may be turned off. The switch (50) may be a switch with an actuator (52) that is pressed by the stylus. The switch may be contacts (250) across which the stylus completes an electrical circuit.

### FIELD OF THE INVENTION

This invention relates to handheld electronic processing apparatus and a method of operating such apparatus. More particularly, but not exclusively, this invention relates to a portable digital assistant (PDA) and an operating system therefor.

### BACKGROUND TO THE INVENTION

Personal digital assistants (PDAs) are handheld, portable, computing devices that provide at least some of the features of a conventional desktop personal computer. Such devices are intended to be of use to those who are not able, or for whom it is inconvenient, to access a conventional desktop personal computer. In order to be truly portable, PDAs include a dedicated, portable, power-source therein, usually in the form of a battery. One problem associated with PDAs is therefore that they can only be operated for as long as the battery continues to provide electrical power to the PDA. In an attempt to prolong battery life, some PDAs incorporate power saving features such as turning off screen backlights after a predetermined period of user inactivity, and causing the PDA to enter a low-power standby mode after a further period of inactivity. One disadvantage of such power-saving features, however, is that they can cause the PDA to become inoperable at a time inconvenient to the user; and may also cause the PDA to remain operable for periods during which operation is not required by the user.

It is an object of this invention to address this disadvantage.

### SUMMARY OF THE INVENTION

According to one aspect of this invention, there is provided a method of operating handheld electronic processing apparatus, the apparatus having a housing in which a display screen is mounted, and having a stylus that can be accommodated at least partly in a stylus accommodation portion of the housing, wherein the display screen is arranged for displaying information and is sensitive to the touch of the stylus to receive a data input, the method including the steps of:

a) processing means of the apparatus receiving from sensing means of the apparatus a signal indicative of the presence and/or absence of the stylus in the stylus accommodation portion; and

b) the processing means responding to the signal to move the apparatus between a lower power mode of operation and a higher power mode of operation, the apparatus consuming more power for operation in the higher power mode than in the lower power mode.

Accordingly, the present invention addresses the problem with prior art devices by automatically entering or exiting a power saving mode, depending on whether the stylus has been withdrawn from the PDA by a user, or replaced therein. Thus, instances of the PDA entering a power saving mode at an time inconvenient to the user and remaining at full power when not in user, can be avoided.

The method may include the step of automatically moving to the lower power mode after a period of time in which no input to the apparatus from a user has been received. The method may include the further step of disabling movement of the apparatus between the two power modes in response to the stylus being withdrawn from or inserted into the stylus accommodation portion; and may include the still further step of re-enabling movement of the apparatus between the two power modes in response to the stylus being withdrawn from or inserted into the stylus accommodation portion.

Step (b) may include the processing means disabling some or all of the operational features of the device in order to conserve power when moving the apparatus to the lower power mode. Step (b) may include the processing means enabling some or all of the operational features of the device when moving the apparatus to the higher power mode.

When the processing means receives in step (a) a signal indicative of the stylus not being accommodated in stylus accommodation portion, step (b) may be preceded by the steps of ascertaining which operational features of the apparatus have been disabled to save power, and step (b) may include the step of enabling those features which have been disabled.

According to another aspect of this invention, there is provided handheld electronic processing apparatus having a housing, the housing having a display screen mounted therein and a stylus that can be accommodated at least partly in a stylus accommodation portion thereof, wherein the display screen is arranged for displaying information and is sensitive to the touch of the stylus to receive a data input, and wherein the apparatus includes sensing means arranged to sense the presence and/or absence of the stylus in the stylus accommodation portion.

Preferably, the apparatus can respond to the sensing means sensing the presence and/or absence of the stylus in the stylus accommodation portion to move between a lower power mode of operation and a higher power mode of operation, the apparatus consuming more power for operation in the higher power mode than in the lower power mode.

The apparatus may be arranged such that, upon the sensing means sensing the absence of the stylus, the apparatus moves from the lower power mode to the higher power mode. The apparatus may be arranged such that, upon the sensing means sensing the presence of the stylus, the apparatus moves from the higher power mode to the lower power mode.

The lower power mode may be a mode in which some or all of the operational features of the apparatus are disabled in order to conserve power. In particular, features of the apparatus that tend to require most power for their operation may be disabled. For example, in the lower power mode, light-emitting means of the apparatus, such as a backlight for the display screen, may be turned off; sound emitting means of the apparatus, such as a speaker, may be turned off; the display screen may be turned off; and/or wireless transceiving means, such as a Wi-Fi transceiver, may be turned off. The lower power mode may be a standby mode in which substantially all processing operations of the apparatus are suspended, but in which information is retained in volatile memory of the apparatus. The lower power mode may be a hibernate mode in which substantially all processing operations of the apparatus are suspended and information resident in volatile memory of the apparatus is written to non-volatile memory thereof. The lower power mode may be a mode in which the apparatus is powered down so as to be substantially turned off.

There may be more than one lower power mode. For example, there may be a first lower power mode in which the apparatus is turned off, is hibernating or in on standby; there may be a second lower power mode in which the display screen and the backlight are turned off, but in which the apparatus is operational; and there may be a third lower power mode in which, the backlight is turned off, but the display screen is turned on and the device is operational.

Preferably the higher power mode is a normal operating mode.

Preferably the sensing means includes a switch that is arranged so as to be changed between different states when the stylus is moved between a position in which it is in the stylus accommodation portion and a position in which it is not in the stylus accommodation portion. Preferably the apparatus includes processing means that is responsive to changes in an output signal from the switch to move the apparatus between the lower power mode and the higher power mode. In one embodiment, the sensing means includes a micro-switch that at least partly projects into space to be occupied by the stylus in the stylus accommodation portion, such that the micro-switch is contacted and closed by the stylus when the stylus is accommodated in the stylus accommodation portion, and such that the micro-switch opens when the stylus is withdrawn from that portion.

The switch may include contacts that are accessible from the stylus accommodation portion, and the stylus may include an electrically-conducting portion that is arranged to connect the contacts together when the stylus is in the stylus accommodation portion, thereby changing the state of the switch

The apparatus may include a power button operable by a user to move the apparatus between the, or another, lower power mode and the, or another, higher power mode.

The apparatus may be arranged such that movement thereof between the two power modes in response to the stylus being withdrawn from or inserted into the stylus accommodation portion can be disabled. The apparatus may include user-operable disabling means in order to disable such automatic movement between the two power modes. The user-operable disabling means may include a switch or button in the housing of the apparatus. The user-operable disabling means may be operated by providing one or more inputs to the apparatus by touching the stylus on the display screen.

In a preferred embodiment, the apparatus is a personal digital assistant (PDA). The apparatus may be a PDA for use in an industrial environment such as, for example, collecting data on a workshop floor or for stock control purposes in an industrial store of manufactured goods or material. The apparatus may be personal computing means in the form of, for example, a palmtop computer, laptop computer or tablet PC. The apparatus may be mobile telecommunications means in the form of, for example, a smartphone. The apparatus may be a gaming device on which video games can be played.

According to a further aspect of this invention, there is provided an operating system for handheld electronic processing apparatus, the operating system being executable by the apparatus to cause that apparatus to carry out the method of the first aspect of this invention.

According to a still further aspect of this invention, there is provided a record carrier having recorded therein information which is executable by handheld electronic processing apparatus to cause that apparatus to carry out the method of the first aspect of this invention.

The record carrier may be a signal such as, for example, a wireless radio signal, a light signal or an electrical signal. The record carrier may be a medium such as, for example, a magnetic or optical storage disk, or a non-volatile solid-state storage device.

### BRIEF DESCRIPTION OF THE DRAWINGS

Specific embodiments of this invention are described below by way of example only and with reference to the accompanying drawings, in which:

FIG. 1 is a front elevation view of a personal digital assistant (PDA) embodying the invention;

FIG. 2 is a fragmentary perspective view of the back of the PDA shown in FIG. 1, a stylus being shown partially withdrawn from the body of the PDA;

FIG. 3 is the same view as that of FIG. 2, but shows the stylus fully inserted into the body of the PDA;

FIG. 4 is a schematic sectional view of the stylus in the PDA, the stylus being partially withdrawn from the body of the PDA;

FIG. 5 is a schematic sectional view of the stylus in the PDA, the stylus being fully inserted into the body of the PDA;

FIG. 6 is a flow diagram showing a method carried out by the PDA that embodies the invention; and

FIG. 7 is a schematic sectional view of another PDA that is another embodiment of the invention.

### SPECIFIC DESCRIPTION OF CERTAIN EXEMPLARY EMBODIMENTS

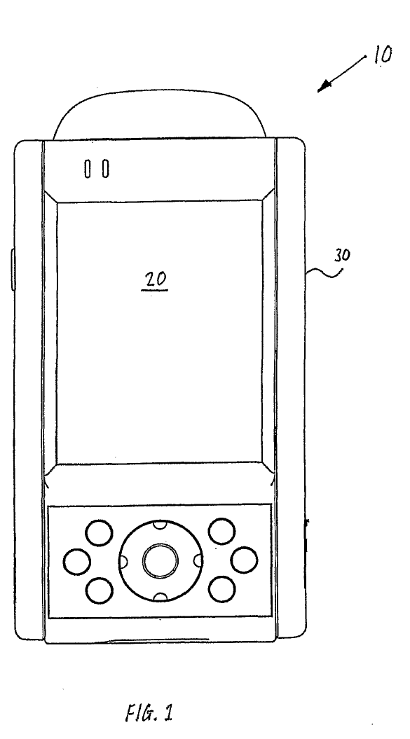

FIG. 1 shows handheld electronic processing apparatus in the form of a personal digital assistant (PDA) 10. The PDA 10 is shaped as a generally rectangular slab or tablet that is of a size which allows it to be gripped in a user's hand. A front face of the PDA 10 has a display screen 20 mounted therein. The display screen 20 is touch sensitive and in use acts as a graphical user interface. Accordingly, during use, the PDA 10 is positioned with the display screen facing towards the user. The PDA 10 has a plastic casing 30 that is designed to assist in protecting components of the PDA 10 from damage when the PDA 10 is subject to mechanical shocks, such as those resulting from the PDA 10 being dropped. The plastic casing 30 fits around the components of the PDA 10 so as to resist the ingress of extraneous matter.

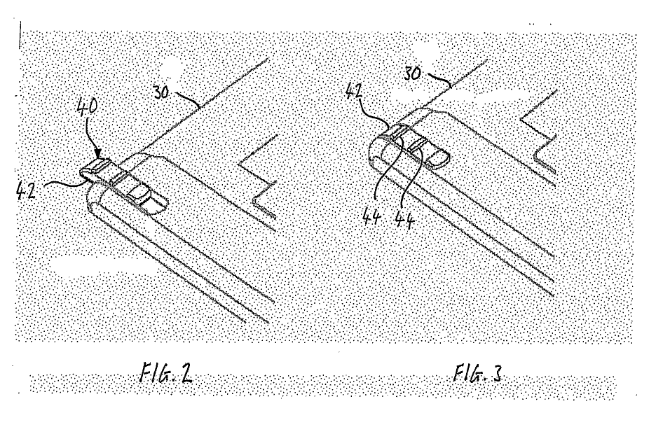

FIG. 2 shows a corner part of PDA that would be the top, right-hand, corner during use. FIG. 2 shows that corner part from the back of the PDA 10, the back being the side of the PDA 10 that is opposite the display screen 20. With continued reference to FIG. 2, it can be seen that the PDA 10 includes a stylus 40. The stylus 40 is shaped generally like a short, thin, writing implement, being elongate, spherical, and coming to a point at one end (not shown in FIG. 2). The other end 42 of the stylus 40 includes an endstop 44. The stylus 40 is accommodated in a blind bore (not shown in FIG. 2) formed in the casing 30 of the PDA 10 so as to extend adjacent and parallel to one long side of the rectangular PDA 10. The stylus 40 can be slid into and slid out of the bore in the casing 30. The stylus 40 is slid out of the casing 30 for use in pressing against and tracing across the touch-sensitive screen 20 when data is to be inputted into the PDA 10; and is slid back into the bore when operation of the touch-sensitive screen 20 is not required.

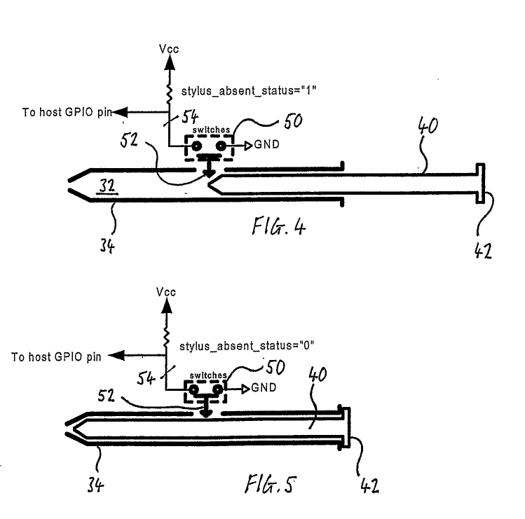

FIG. 3 shows the stylus 40 slid into a position in which it is accommodated in the bore in the casing 30 to its fullest extent. In this position, the endstop 42 abuts against structure of the casing 30 surrounding the bore therein and so prevents the stylus 40 from entering the bore any further. To aid extraction of the stylus 40, the endstop 42 includes ridges 44 thereon to encourage grip between a finger or thumb of the user and the endstop 42.

FIG. 4 is a schematic, sectional, diagram of the stylus 40 and adjacent parts of the PDA 10, with the section being along the axis of the stylus and in a radial plane with respect thereto. Thus the stylus-receiving bore 32 in the casing 30 is shown in FIG. 4, together with immediately-surrounding structure 34 of the casing 30 that defines the bore 32. This immediately-surrounding structure 34 therefore serves as a stylus accommodation portion 34 of the PDA 10.

With continued reference to FIG. 4, sensing means in the form of a micro-switch 50 is mounted in the casing 30 such that an actuator 52 of the micro-switch 50 tends to project into the bore 32. The micro-switch 50 is positioned so as to be part way along the length of the bore 32, rather than towards one end. The arrangement is such that, when the stylus 40 does not extend past the actuator 52 in the bore 32, the actuator 52 is unobstructed and is free to project into the bore 32, thereby placing the micro-switch 50 in an open state. As can be seen in FIG. 5, when the stylus 40 does extend past the actuator 52 in the bore 32, the presence of the stylus forces the actuator 52 out of the bore 32 and closes the micro-switch 50.

The micro-switch is arranged to produce an output signal. In this embodiment, the output signal is named “STYLUS_ABSENT_STATUS”. The arrangement is such that, when the micro-switch is open, the STYLUS_ABSENT_STATUS signal is a logic 1; and when the micro-switch is closed, the STYLUS_ABSENT_STATUS signal is a logic 0.

An output 54 of the micro-switch is connected to an input of processing means of the PDA 10 in the form of a central processing unit (not shown) so as to convey the STYLUS_ABSENT_STATUS signal thereto. The central processing unit is arranged to control operation of the display screen 20, including a backlight of the display screen; and is further able to cause the PDA 10 to be powered down so as to be effectively turned off.

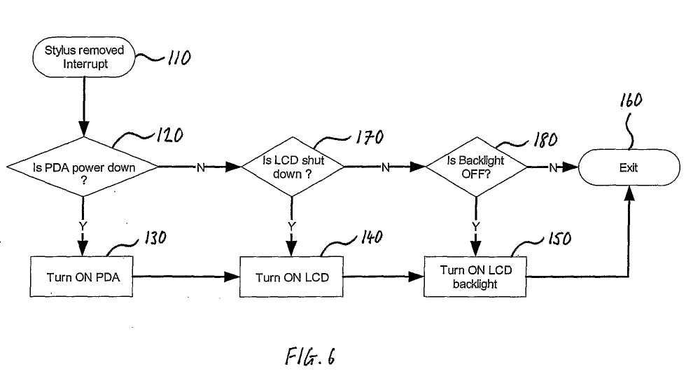

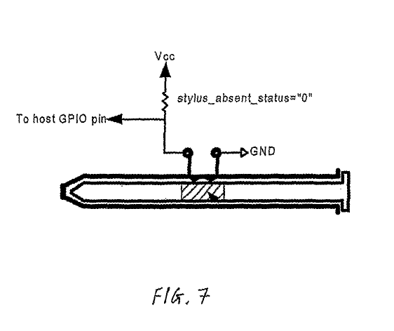

Operation of the PDA 10 will now be described. The PDA 10 has stored in flash memory an operating system that governs the way in which the PDA 10 operates. The operating system includes a method having logic steps that determine what actions, if any, are taken by the central processing unit upon the stylus 40 being inserted into the bore 32 or removed therefrom. This method 100 is described below with reference to FIG. 6.

In order to use the PDA, a user first withdraws the stylus 40 from the bore 32 in the casing 30. As the tip of the stylus 40 is withdrawn past the actuator 52 of the micro-switch 50, the actuator is free to move into the bore 32, causing the micro-switch 50 to open. Once opened, the micro-switch 50 changes the STYLUS_ABSENT STATUS signal to a logic 1. This signal is received by the central processing unit at block 110 of FIG. 6 as “Stylus removed interrupt”. This causes the method to proceed begin at block 120 by the central processing unit ascertaining whether or not the PDA 10 is powered down. If it is, the method moves to blocks 120, 130 and 140 in which, respectively, the PDA is turned on, the display screen 20 is turned on, and the display screen backlight is turned on. The method 100 then proceeds to block 160 in which it is terminated.

If, however, at block 120 the central processing unit finds that the PDA is not powered down, the method proceeds to block 170 in which it ascertains whether or not the display screen 20 is turned off. If it is, the method 100 proceeds to turn on the display screen in block 140 and the backlight in block 150, before terminating the method 100 at block 160.

If it is determined at block 170 that the display screen 20 is not turned off, the method 100 proceeds to block 180 in which the central processing unit ascertains whether or not the backlight is turned off. If it is turned off, the method 100 proceeds to turn on the backlight in step 150 before terminating the method in block 160. If the backlight is not turned off, the method 100 proceeds directly to block 160 and terminates.

With the stylus 40 fully withdrawn from the bore 32, and with the PDA, the display screen 20 and the backlight all turned on, the PDA 10 is ready for use by a user.

When the user no longer wishes to use the PDA 10, he or she replaces the stylus 40 by inserting it to its fullest extent into the bore 32. As the tip of the stylus 40 passes the actuator 52 of the micro-switch 50, the actuator is forced out of the bore, causing the micro-switch 50 to close and the STYLUS_ABSENT_STATUS signal to become a logic 0. In response to the central processing unit receiving this signal, the method 100 causes the PDA 10, the display screen 20 and the backlight to power down.

An alternative embodiment of this invention is shown in FIG. 7. In this embodiment, an industrial PDA is provided that is suited for use in factories, workshops, storage facilities and other industrial settings in which there is an environment harsher than that found in, for example, a professional office. Accordingly, the industrial PDA is intended to be especially resistant to the ingress of extraneous particles and fluids that are to be found in such industrial settings and which might otherwise damage the PDA.

The industrial PDA differs from the PDA 10 described above by the substitution of two insert-moulded contacts 250 for the micro-switch 50. The insert-moulded contacts 250 are a pair of spaced-apart metal contacts. The contacts 250 are embedded in material 354 of the casing of the PDA that surrounds the stylus-receiving bore, and so as to project through that material into the bore. The contacts 250 are positioned at about half way along the length of the bore. The contacts are embedded such that there is no gap between the contacts and surrounding material of the casing through which extraneous matter can pass. Thus, such matter which enters the bore is kept from entering the inside of the casing 30 where it might damage internal components of the PDA

The industrial PDA includes a stylus 240 that includes an electrically-conductive portion at about half way along its length. In this embodiment, the electrically-conductive portion is a cylindrical ring of metal 260 that surrounds a portion of the stylus 240 that is of reduced diameter with respect to the remainder of the stylus. The arrangement is such that the outside surface of the ring of metal 260 is flush with the outside surface of surrounding structure of the stylus 240.

In operation, inserting the stylus 240 into the bore to its furthest extent, causes the ring of metal 260 to connect the two contacts 250 together. When connected together, the contacts output a STYLUS_ABSENT_STATUS signal having a value of logic 0 to a central processing unit in a similar manner to that of the first PDA 10 described above. When the stylus 260 is withdrawn, the connection between the contacts 250 is broken and a STYLUS_ABSENT_STATUS signal having a value of logic 1 is sent to the central processing unit. All other aspects of the operation of this industrial PDA are substantially the same as those of the first PDA described above. In particular, the central processing unit in this industrial PDA responds to these signals in the same way as that of the first PDA 10 described above and operates in accordance with substantially the same operating system.

That which is claimed:

1. A method of operating a handheld electronic processing apparatus, the apparatus having a housing in which a display screen is mounted, and having a stylus capable of being accommodated at least partly in a stylus accommodation portion of the housing, wherein the display screen is arranged for displaying information and is sensitive to the touch of the stylus to receive a data input, the method comprising the steps of:
a) processing means of the apparatus receiving from sensing means of the apparatus a signal indicative of one of a presence and absence of the stylus in the stylus accommodation portion; and
b) the processing means responding to the signal to move the apparatus between a lower power mode of operation and a higher power mode of operation, the apparatus consuming more power for operation in the higher power mode than in the lower power mode.

2. A method according to claim 1, wherein step (b) includes the processing means moving the apparatus from the lower power mode to the higher power mode upon the sensing means sensing the absence of the stylus.

3. A method according to claim 1, wherein step (b) includes the processing means moving the apparatus from the higher power mode to the lower power mode, upon the sensing means sensing the presence of the stylus.

4. A method according to claim 1, wherein step (b) includes the processing means disabling at least one operational feature of the device in order to conserve power when moving the apparatus to the lower power mode.

5. A method according to claim 1, wherein step (b) includes the processing means enabling at least one operational feature of the device when moving the apparatus to the higher power mode.

6. The method according to claim 1, further comprising the step of automatically moving to the lower power mode after a period of time in which no input to the apparatus from a user has been received.

7. A method according to claim 1, further comprising the step of disabling movement of the apparatus between the two power modes in response to the stylus being withdrawn from or inserted into the stylus accommodation portion.

8. A method according to claim 7 and further comprising the step of re-enabling movement of the apparatus between the two power modes in response to the stylus being one of withdrawn from and inserted into the stylus accommodation portion.

9. A method according to claim 1, wherein when the processing means receives in step (a) a signal indicative of the stylus not being accommodated in stylus accommodation portion, step (b) is preceded by the steps of ascertaining which operational features of the apparatus have been disabled to save power, and step (b) further includes the step of enabling those features which have been disabled.

10. A handheld electronic processing apparatus having a housing, the housing having a display screen mounted therein and a stylus capable of being accommodated at least partly in a stylus accommodation portion thereof, wherein the display screen is arranged for displaying information and is sensitive to the touch of the stylus to receive a data input, and wherein the apparatus includes sensing means arranged to sense one of the presence and absence of the stylus in the stylus accommodation portion, wherein the apparatus is capable of responding to the sensing means sensing the one of the presence and absence of the stylus to move between a lower power mode of operation and a higher power mode of operation, the apparatus consuming more power for operation in the higher power mode than in the lower power mode.

11. An apparatus according to claim 10, and further arranged such that, upon the sensing means sensing the absence of the stylus, the apparatus moves from the lower power mode to the higher power mode.

12. An apparatus according to claim 10, being further arranged such that, upon the sensing means sensing the presence of the stylus, the apparatus moves from the higher power mode to the lower power mode.

13. An apparatus according to claim 10, wherein the lower power mode is a mode in which at least one operational feature of the apparatus is disabled in order to conserve power.

14. An apparatus according to claim 13, wherein, in the lower power mode, light-emitting means of the apparatus, such as a backlight for the display screen, is turned off.

15. An apparatus according to claim 13, wherein, in the lower power mode, the display screen is turned off.

16. An apparatus according to claim 10, wherein the lower power mode is a mode in which the apparatus is powered down so as to be substantially tuned off.

17. An apparatus according to claim 10 wherein there is a plurality of modes: a first lower power mode in which the apparatus is powered down; a second lower power mode in which the display screen and the backlight are turned off, but in which the apparatus is operational; and a third lower power mode in which the backlight is turned off, but the display screen is turned on and the device is operational, the apparatus being caused to move to and/or between all of these modes.

18. An apparatus according to claim 10, wherein the sensing means includes a switch that is arranged so as to change between different states when the stylus is moved between a position in which it is in the stylus accommodation portion and a position in which it is not in the stylus accommodation portion, and thereby to provide different output signals indicative of this to which the apparatus is capable of responding.

19. An apparatus according to claim 18, wherein the switch includes a micro-switch that at least partly projects into space to be occupied by the stylus in the stylus accommodation portion, such that the micro-switch is contacted and closed by the stylus when the stylus is accommodated in the stylus accommodation portion, and such that the micro-switch opens when the stylus is withdrawn from that portion.

20. An apparatus according to claim 18, wherein the switch includes contacts that are accessible from the stylus accommodation portion, and the stylus includes an electrically conducting portion that is arranged to connect the contacts together when the stylus is in the stylus accommodation portion, thereby changing the state of the switch.

21. An apparatus according to claim 20, wherein the contacts project through material of the housing into the stylus accommodation portion such that substantially no gap exists between the contacts and the material of the housing, thereby guarding against extraneous matter passing from the stylus accommodation portion to inside the housing.

22. An apparatus according to claim 10, wherein the apparatus includes a power button operable by a user to move the apparatus between power modes.

23. An apparatus according to claim 10, wherein the apparatus is arranged such that movement thereof between power modes in response to the stylus being one of withdrawn from and inserted into the stylus accommodation portion can be is capable of being disabled.

24. An apparatus according to claim 10, wherein the apparatus includes user-operable disabling means in order to disable automatic movement between power modes.

25. An apparatus according to claim 10, wherein the apparatus is a personal digital assistant (PDA).

26. An apparatus according to claim 10, further comprising an operating system being executable by the apparatus to cause that apparatus to be operated.

27. An apparatus according to claim 10, further comprising a record carrier having recorded therein information which is executable by the apparatus to cause that apparatus to be operated.

28. An apparatus according to claim 27, wherein the record carrier comprises one of a wireless radio signal, a light signal and an electrical signal.

29. An apparatus according to claim 27, wherein the record carrier comprises one of a magnetic storage disk, an optical storage disk, and a non-volatile solid-state storage device.
